(19) United States
(12) Patent Application Publication
(10) Pub. No.: US 2001/0033396 A1
(43) Pub. Date: Oct. 25, 2001

(54) Image processing apparatus with a hidden control panel

(76) Inventor: Thomas Sheng, Hsinchu (TW)

Correspondence Address: RABIN & CHAMPAGNE, PC, 1101 14TH STREET, NW, SUITE 500, WASHINGTON, DC, 20005, US

(21) Appl. No.: 09/810,442

(22) Filed: Mar. 19, 2001

(30) Foreign Application Priority Data
Apr. 19, 2000 (TW) 89206411

(51) Int. Cl. H04N 1/32

(52) U.S. Cl. 358/468

(57) ABSTRACT

An image processing apparatus with a hidden control panel. The image processing apparatus includes a main body, a control panel, and an internal storage slot formed in the main body. The control panel includes a keyboard for being inputted instructions for operating the image processing apparatus. The control panel may be inserted or hidden into the internal storage slot. The display panel displays the inputting instructions and the status of the image processing apparatus.

This application incorporates by reference Taiwanese application Serial No. 89206411, Filed Apr. 19, 2000.

### BACKGROUND OF THE INVENTION

### Field of the Invention

The invention relates in general to an image processing apparatus having a hidden control panel, and more particularly to an image processing apparatus containing a hidden unit that combines a controlling keyboard and a display panel.

### Description of the Related Art

Multi-Function Peripherals (MFPs) that combine the functions of a scanner, copy machine, facsimile machine, and printer are highly needed in this technologically demanding world. The development of MFPs has been towards the incorporation of the ability of sending and receiving emails. This would require the MFP to include a fully functional keyboard with a full complement of keys as any ordinary keyboard.

Currently, flat-bed and sheet-fed designs are two of the more popular designs for digital image processing apparatuses. Flat-bed designs are more popular due to their better image quality. However, the presence of the top cover, which is an essential part of flat-bed devices, occupies most of the device's top surface and leaves little room for the incorporation of a keyboard.

In comparison, sheet-fed apparatuses allow more freedom in the area of keyboard design. F@x Internet 750, a color facsimile machine made by SAGEM, is a sheet-fed digital processing apparatus able to scan, copy, fax, and transmit documents over the Internet. FIG. 1 shows the F@x Internet 750. The facsimile machine 10 includes a sheet-fed unit 11 arranged above the apparatus, and a control panel 12, which has a display panel 14 and a keypad 16 on the front thereof. Even though more space is available, it is still insufficient for the incorporation of a full complement of keys as in the standard keyboard. As a result, many characters and functions are accessed through a combination of keystrokes, which is highly inconvenient and inefficient. Furthermore, as Chinese characters are steadily being incorporated in the IP addresses, the need for more keys will only increase. Therefore, a good keyboard design for MFPs is a concern for now and the future.

HP Digital Sender 8100C, a flat-bet MFP and shown in FIG. 2, is designed with its control panel 26 over the cover 22 to reduce the overall size of the unit. It is also a device capable of scanning, copying, faxing, printing, and transmitting documents over the internet. HP Digital Sender 8100C 20 includes a document feeding unit 24 and a control panel 26 over the cover 22. The control panel 26 has a display panel 27 and a full function keypad 28. However, the HP Digital Sender 8100C is still difficult to use because the keypad is located at the rear of the machine.

### SUMMARY OF THE INVENTION

It is therefore an object of the invention to provide an image processing apparatus having a hidden control panel, which more effectively uses the space of the image processing apparatus. The control panel can be drawn out when needed and pushed back in after use. In this way, the size of the imaging processing apparatus is minimized.

It is another objective of the invention to provide an image processing apparatus with a hidden control panel. The image processing apparatus includes a main body, a control panel and an internal storage area in the main body. The control panel includes a keyboard for inputting the device's operating instructions in addition to information. The control panel may be drawn out of and pushed back into the storage area. The display panel displays the instructions and the status of the image processing apparatus.

The image processing apparatus, according to one object of the invention includes, for example, a printer, copy machine, facsimile machine, and scanner.

### BRIEF DESCRIPTION OF THE DRAWINGS

Other objects, features, and advantages of the invention will become apparent from the following detailed description of the preferred but non-limiting embodiments. The description is made with reference to the accompanying drawings in which:

FIG. 1 shows the appearance of a conventional sheet-fed digital processing apparatus, F@x Internet 750;

FIG. 2 shows the appearance of a conventional flat-bed digital processing apparatus, HP Digital Sender 8100C;

FIGS. 3A and 3B show the appearance of a MFP with a hidden control panel according to a preferred embodiment of the invention;

FIG. 4A shows the sliding portion and the corresponding sliding guide in the internal storage slot according to a preferred embodiment of the invention;

FIG. 4B shows guide wheels at two sides of the control panel according to a preferred embodiment of the invention.

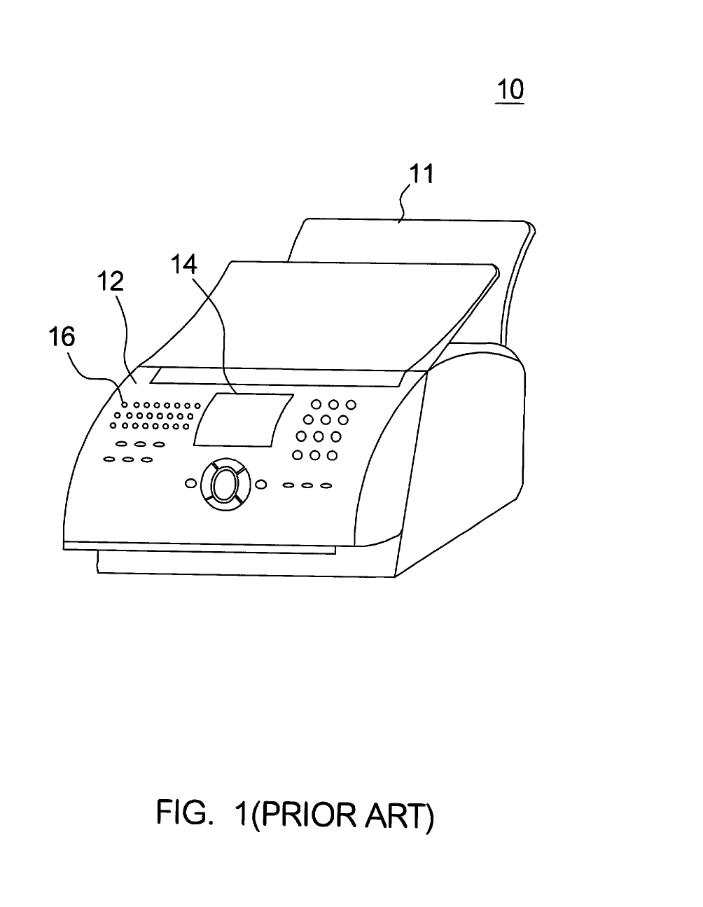

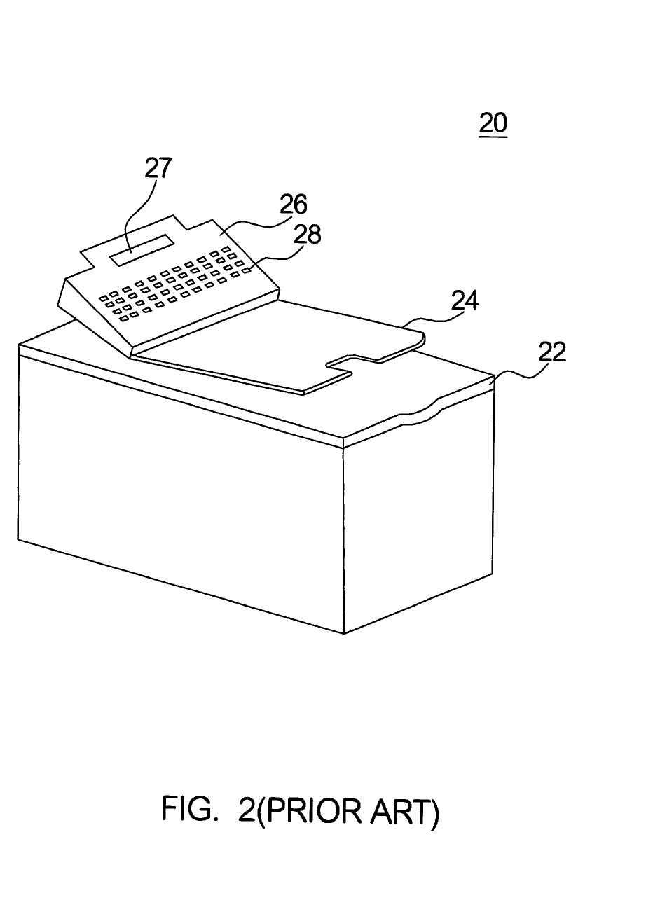

### DESCRIPTION OF THE PREFERRED EMBODIMENT

According to a preferred embodiment of the invention, a hidden control panel is applied to an image processing apparatus. It is well known for people who are skilled in this art that the term “image processing apparatus” encompasses at least the following: a printer, copy machine, facsimile machine, scanner, and Multi-Function Peripheral (MFP). In the following, a MFP with a built-in modem for e-mail transmittal or MFP transmitting image signal via telephone cable is taken as an example for illustrating. However, it is clear for those who are skilled in this art that the invention is not limited thereto.

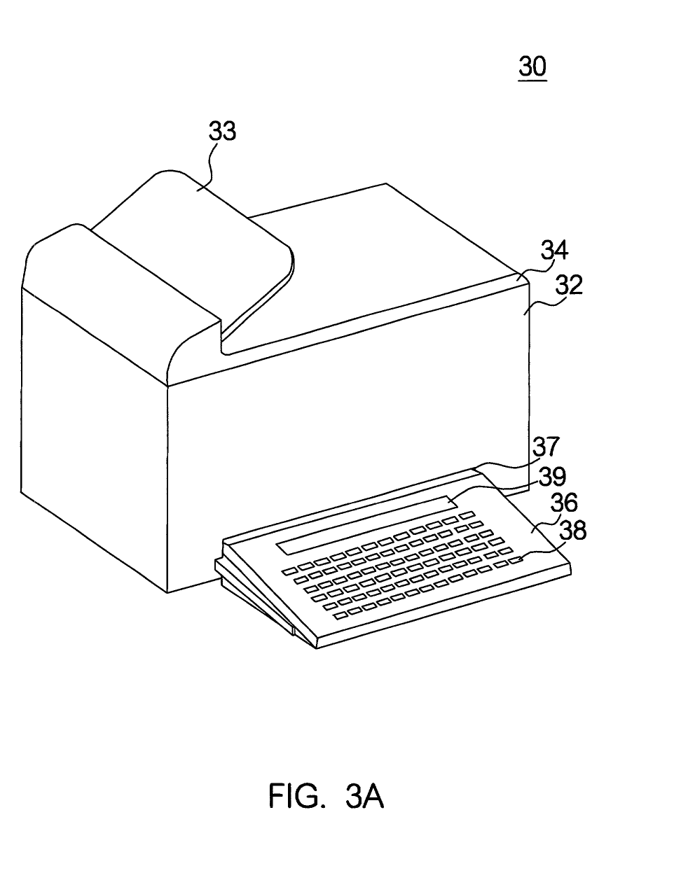

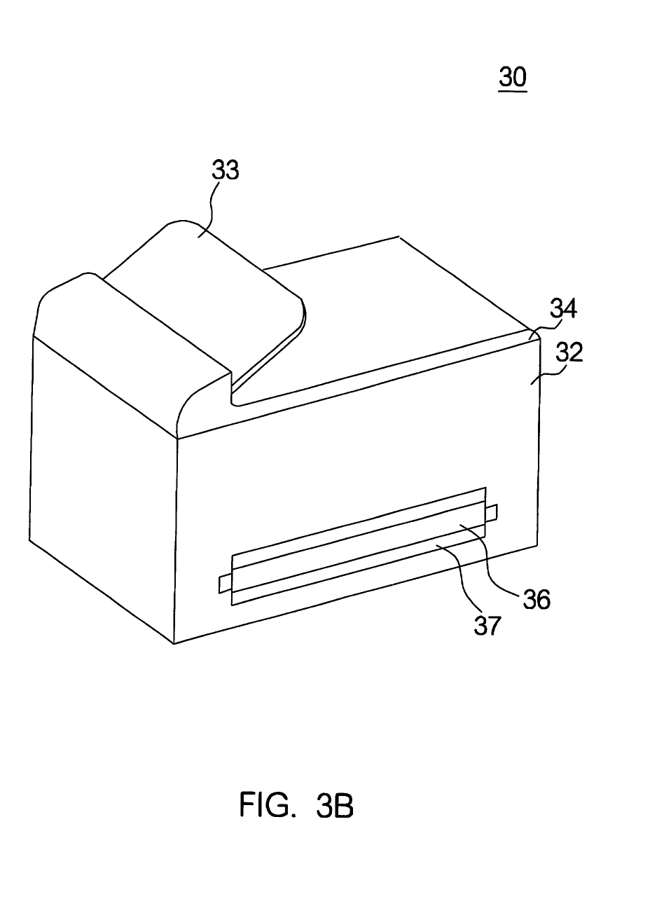

The appearance of a MFP with a hidden control panel according to a preferred embodiment is illustrated in FIGS. 3A 3B. The MFP 30 includes a main body 32, a cover 34 having a document feeding unit 33, a hidden control panel 36, and an internal storage slot 37 in the main body 32. The document feeding unit 33 is arranged above the main body 32. The control panel 36 is disposed at or received in the internal storage slot 37 inside the main body 32 and can be drawn out when needed, as shown in FIG. 3A. The control panel 36 includes a controlling keyboard 38 and a display panel 39, which is electrically coupled to the control panel 36. The controlling keyboard 38 can be a conventional Typewriter Style Keyboard. The Typewriter Style Keyboard can be inputted a large variety of letters, numbers, and symbols. The display panel 39 displays inputted instructions and the status of the MFP, such as sending or receiving facsimile, dialing or e-mail transmitting.

FIG. 3B shows the MFP according to a preferred embodiment of the invention, while the control panel 36 is pushed back. When the control panel 36 is not used, such as after inputting or while receiving facsimile document, it can be pushed back in the internal storage slot 37.

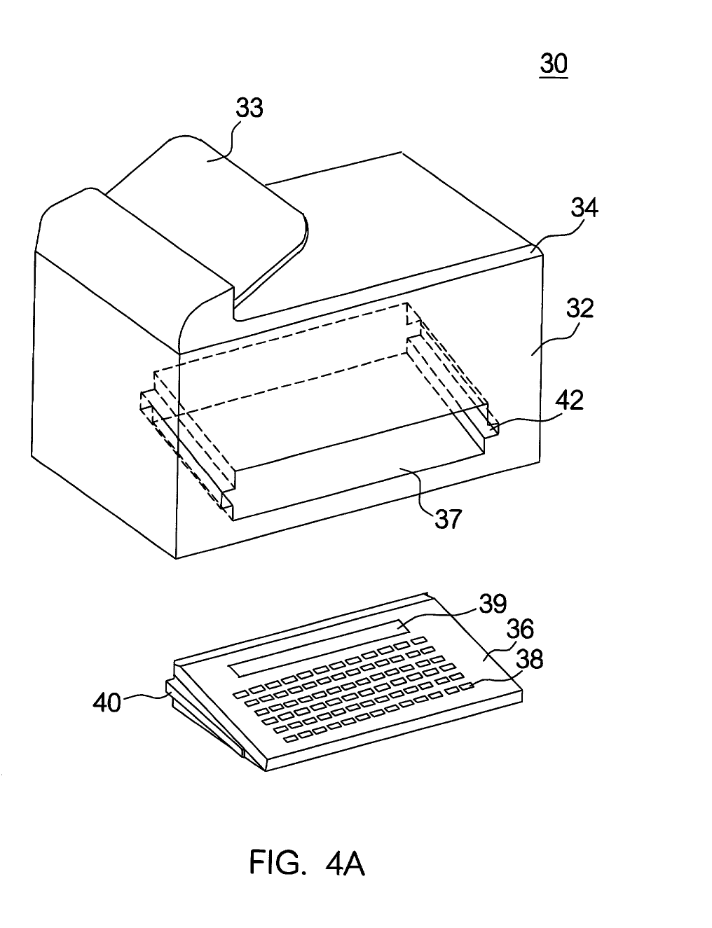

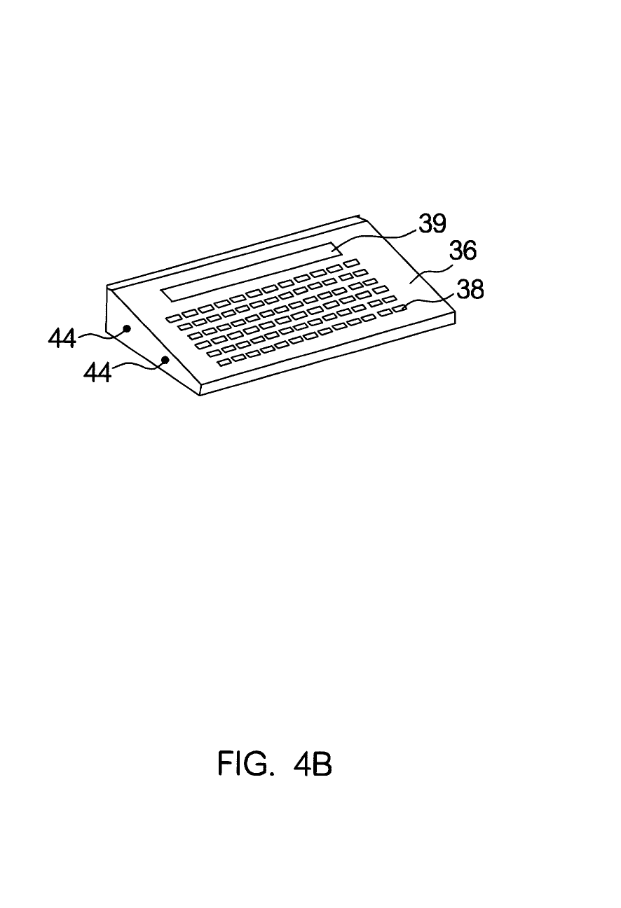

According to a preferred embodiment of the invention, the hidden control panel 36 can be drawn out and pushed in by the aid of sliding guides or guide wheels. As shown in FIG. 4A, there are at least two sliding portions 40 projecting from either side of the control panel 36, and corresponding sliding guides 42 in the internal storage slot 37. When the control panel 36 is drawn out or pushed in, the sliding movement of the control panel 36 is guided by the sliding guides 42 while the control panel 36 is supported by the sliding portions 40. Alternatively, as shown in FIG. 4B, there can be at least two guide wheels 44 at either side edge of the control panel 36. By the aid of the guide wheels 44, the control panel 36 can be removed along the sliding guides 42 more easily because of reduced friction.

Alternatively, an infrared transmission device (not shown) can be installed in the control panel 36. In this way, the control panel 36 can be completely withdrawn and disconnected from the main body 32 of the MFP. Instructions and information will then be transmitted to the MFP in a wireless manner.

The image processing apparatus according to a preferred embodiment of the invention has a hidden or movable control panel so that the control panel can be pushed into the main body of the apparatus when it is not used. Consequently, the image processing apparatus occupies less area as a whole. Moreover, the control panel has a full complement of keys as a regular keyboard, which is ideal in terms of convenience and efficiency.

It is clear to people who are skilled in this art that the application of the hidden control panel can be used in any image processing apparatus and not limited to MFPs.

While the invention has been described by way of example and in terms of the preferred embodiment, it is to be understood that the invention is not limited to the disclosed embodiment. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image processing apparatus, comprising:
a main body;
an internal storage slot formed in the main body; and
a control panel moveably received in the internal storage slot, wherein the control panel comprises a keyboard through which the instructions for operating the image processing apparatus are inputted.

2. The image processing apparatus as claimed in claim 1, wherein the control panel is slidably received in the internal storage slot.

3. The image processing apparatus as claimed in claim 1, further comprising:
a display panel electrically connected to the control panel for displaying the inputted instructions and the status of the image processing apparatus.

4. The image processing apparatus as claimed in claim, further comprising:
a document-feeding unit arranged above the main body for feeding documents into the image processing apparatus.

5. The image processing apparatus as claimed in claim 1, wherein the image processing apparatus is a printer.

6. The image processing apparatus as claimed in claim 1, wherein the image processing apparatus is a copy machine.

7. The image processing apparatus as claimed in claim 1, wherein the image processing apparatus is a facsimile machine.

8. The image processing apparatus as claimed in claim 1, wherein the image processing apparatus is a scanner.

9. The image processing apparatus as claimed in claim 1, wherein the image processing apparatus is a Multi-Functional Peripheral.

10. The image processing apparatus as claimed in claim 1, wherein the image processing apparatus further comprises a built-in modem.

11. The image processing apparatus as claimed in claim 1, wherein the control panel is further installed with an infrared transmission device.
